(19) United States
(12) Patent Application Publication
(10) Pub. No.: US 2007/0231060 A1
(43) Pub. Date: Oct. 4, 2007

(54) Sealing Bellows

(75) Inventor: Olaf Abels, Damme (DE)

Correspondence Address: MCGLEW & TUTTLE, PC, P.O. BOX 9227, SCARBOROUGH STATION, SCARBOROUGH, NY, 10510-9227, US

(73) Assignee: ZF FRIEDRICHSHAFEN AG, Friedrichshafen (DE)

(21) Appl. No.: 10/599,746

(22) PCT Filed: Apr. 4, 2005
(86) PCT No.: PCT/DE05/00595

§ 371 Date: Jun. 11, 2007

(30) Foreign Application Priority Data
Apr. 8, 2004 (DE) 10 2004 018 054.7

(51) Int. Cl. F16C 11/06

(52) U.S. Cl. 403/76

(57) ABSTRACT

A sealing bellows is provided for a ball-and-socket joint having a ball with a pivot (6) originating from the ball and a housing (40) accommodating the ball. The sealing bellows extends between the pivot (6) and the ball housing. The sealing bellows has a pivot-side sealing area (12), a jacket area (13) and a housing-side sealing area (24) consisting of an elastomeric material. At least one sealing area (12) consists of an elastomeric material different from that of the jacket area (13).

### CROSS REFERENCE TO RELATED APPLICATIONS

This application is a United States National Phase application of International Application PCT/DE 2005/000595 and claims the benefit of priority under 35 U.S.C. §119 of German Patent Application DE 10 2004 018 054.7 filed Apr. 8, 2004, the entire contents of which are incorporated herein by reference.

### FIELD OF THE INVENTION

The present invention pertains to a sealing bellows of a ball-and-socket joint, with a ball, a pivot originating from the ball and a housing accommodating the ball, the sealing bellows extending between the pivot and the ball housing and the sealing bellows having a pivot-side sealing area, a jacket area and a housing-side sealing area and consisting of at least one elastomeric material.

### BACKGROUND OF THE INVENTION

Concerning the concrete design of a ball-and-socket joint with a sealing bellows, reference is made, for example, to the Offenlegungsschrift DE 102 39 266 A1. The jacket area of a bulged shape and the sealing area at the pivot and at the housing of a ball-and-socket joint are shown here in a detail view in FIG. 1 of DE 102 39 266 A1.

In conventional sealing bellows of ball-and-socket joints, the usual sealing material in the sealing area consists of the same material that is used for the jacket area. This is mostly an elastomer, usually a rubber. A chloroprene rubber is used in most cases.

Since the sealing area of the sealing bellows consists of the same elastomeric material as the jacket area, a material whose properties are suitable for both the mechanical loads of the jacket area and for the tribological requirements of the sealing area must be selected.

This causes the selection of the materials to have to be limited to a few types of elastomers, because only materials whose property profile are acceptable for both the two sealing areas and the jacket area can be used. As a consequence, a material is selected that is not the best material for both the jacket area and the sealing area but represents the best compromise for the respective areas.

### SUMMARY OF THE INVENTION

The object of the present invention is therefore to design a sealing bellows of a ball-and-socket joint such that this sealing bellows is better adapted in the different areas to the respective requirements, for example, concerning mechanical load as well as tribological load.

According to the invention, a sealing bellows of a ball-and-socket joint is provided. The ball-and-socket joint has a ball, a pivot originating from the ball and a housing accommodating the ball. The sealing bellows extends between the pivot and the ball housing and the sealing bellows and has a pivot-side sealing area, a jacket area and a housing-side sealing area. The jacket area is formed of an elastomeric material. The pivot-side sealing area of the sealing bellows consists of a material that differs from the material of the jacket area of the sealing bellows.

The inventor has recognized that it is favorable for a sealing bellows of a ball-and-socket joint and for the properties thereof if a material that is different from that for the jacket area is selected for the pivot-side sealing area and/or the housing-side sealing area. Thus, the sealing area at the pivot should consist of a slidable material that has a lower coefficient of friction than the material of the pivot. In addition, the pivot-side sealing area should possess good stretching strain and compression strain properties. Similar statements also apply to the housing-side sealing area. By contrast, the jacket area should have sufficient elasticity in order to be able to follow the motions of the pivot.

The sealing area and the jacket area of the sealing bellows may be manufactured, for example, according to the injection molding method, as an inseparable component, in which case different materials are injected into the different areas. However, it is also conceivable that the sealing area and the jacket area are each separate components, which are connected to one another.

This connection may be established both as a non-positive or positive-locking connection or as a connection in substance. Insert parts, which can establish pressed or snap connections and/or are connected to the materials in substance, may be used for this purpose. This method can be combined in diverse embodiments with additional elements, which permit a further improvement ofthe function ofthe sealing elements by centering and support functions. These support and centering elements may consist each of a great variety of materials, for example, plastics, steels or nonferrous metals, and they are thus able, depending on the combination, to make possible, depending on the design, a simple and especially temperature-insensitive and/or corrosion-insensitive support and/or centering.

Thus, it is proposed that a sealing bellows of a ball-and-socket joint, with a ball, a pivot originating from the ball and a housing accommodating the ball, the sealing bellows extending between the pivot and the ball housing and the sealing bellows having a pivot-side sealing area, a jacket area and a housing-side sealing area and consisting of at least one elastomeric material, be improved such that at least one sealing area consists of a material different from that of the elastomeric jacket area.

The material used for the pivot-side sealing area of the sealing bellows is preferably an elastomer, which differs from that used for the jacket area.

Due to the use of different materials for the jacket area and at least one sealing area, adaptation to the particular profile of properties of the particular area can be made possible. For example, a slidable elastomer, which is additionally especially resistant to abrasion, may be used at the pivot-side sealing area. An especially elastic elastomer may be used at the jacket area. However, not only mechanical properties, but also thermal properties can be adapted to the requirements of the particular area by suitably selecting the materials.

It is advantageous if both the pivot-side sealing area and the housing-side sealing area consist of an elastomeric material different from that of the jacket area. All three areas of a sealing bellows can thus be adapted to certain property profiles.

At least one sealing area, preferably both sealing areas, may have a non-positive and/or positive-locking connection and/or a connection in substance with the jacket area. As a result, different connection possibilities can be created for the different areas and materials of the sealing bellows. For example, connection in substance can be established by friction welding or by bonding in case of materials of the sealing area and of the jacket area that can be combined or crosslinked in substance. A positive-locking connection may be selected in case of materials that cannot be either combined in substance or crosslinked. Concerning the possible types of connection of the different areas of the sealing bellows, reference is made to Dubbel: “Taschenbuch für den Maschinenbau” (Mechanical Engineering Manual, paperback edition), 15th edition; chapter Bauteilverbindungen (Connection of Components), pp. 387f.

In an advantageous embodiment of the jacket area of the sealing bellows, at least one reinforcing element, which is preferably arranged close to at least one sealing area, may be inserted at this area. As a result, stabilization of the jacket area can be achieved at the connection point to one sealing area. Especially in case of materials with different elasticities, a high mechanical stress on the softer material due to flexing is reduced by a reinforcing element.

In addition to the reinforcing element of the jacket area, at least one sealing area may have at least one reinforcing element, which is preferably arranged close to the jacket area. The reinforcing elements of the jacket area and of the sealing area create an especially stable connection between the jacket area and the sealing area. Thus, the reinforcing elements effectively prevent the deformation of the individual elements, and the pressing force at the contact site of the jacket area and the sealing area is, furthermore, increased. The reinforcing elements may also be enclosed or embedded in the plastic of the jacket area and/or of the sealing area, optionally on the basis of integration by vulcanization or incorporation by vulcanization.

The reinforcing element may consist of plastic and/or metal. A reinforcing element consisting of plastic may be used, for example, in case of a sealing bellows that is used in an especially damp or watery environment. For example, a sealing bellows of a ball-and-socket joint in a mount in the steering area of a vehicle can be protected from corrosion or exposure to acid by the use of reinforcing elements made of plastic, which are accessible on the surface of the sealing bellows. A reinforcing element made of metal may be used if this is required by especially high operating temperatures of the sealing bellows and of the ball-and-socket joint and a reinforcing element made of plastic is unsuitable because of softening effects.

The reinforcing element may be arranged rotationally symmetrically in relation to the pivot. As a result, uniform stabilization is achieved around the area to be sealed at the pivot and/or at the ball-and-socket joint housing and at the connection point between the sealing area and the jacket area.

In a favorable embodiment variant of the sealing bellows, the jacket area and/or the sealing areas have at least one sealing lip, which makes sealing possible against the housing. This sealing lip, which can be pressed onto the pivot and/or the housing of the ball-and-socket joint, for example, similarly to a leaf spring, prevents dirt or water from entering the bearing area in which the ball is mounted. Conversely, grease or oil present in the ball-and-socket joint housing can be prevented by such a sealing lip from escaping from the sealing bellows.

To make the sealing at the pivot and/or at the housing of the ball-and-socket joint especially reliable, an additional sealing element may be provided as a redundant seal at least at one sealing area. This type of sealing is especially suitable in case of pressures that may possibly develop.

Another advantageous design variant provides for arranging at least one centering element at least between the pivot and the pivot-side sealing area and/or between the housing and the housing-side sealing area. This centering area, which may have a design similar to that of the reinforcing element, makes it possible to optimally align the sealing bellows at the surfaces of the ball-and-socket joint that are to be sealed.

It is advantageous if the jacket area consists of chloroprene rubber, preferably one with a hardness of approx. 50±10 Shore A. Chloroprene rubber is especially resistant to weathering and is elastic at temperatures as low as approx. −40° C. In addition, chloroprene rubber is characterized by oil and grease resistance. The elasticity of the material is adjusted to a range favorable for the jacket area by selecting the Shore A hardness.

Nitrile rubber, such as HNBR, or fluorinated rubber (FPM), preferably with a hardness of approx. 70±10 Shore A, may be advantageously used for the sealing area. These elastomers have excellent sealing properties and their sliding properties can be adapted to the specific application by means of suitable additives. An essential advantage of these materials is their tension set and permanent set, as well as the higher temperature stability.

Other features and advantages of the present invention appear from the claims and the following description of preferred exemplary embodiments with reference to the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a sectional view of the pivot-side sealing area of a sealing bellows with sealing rubber and jacket rubber, which have a reinforcing element and a combined reinforcing/centering element according to the invention;

FIG. 2 is a sectional view of the pivot-side sealing area from FIG. 1 with modified combined reinforcing/centering element, according to the invention, in the jacket rubber;

FIG. 3 is a sectional view of the pivot-side sealing area of a sealing bellows according to an embodiment of a centering element according to the invention;

FIG. 4 is a sectional view of the pivot-side sealing area of a sealing bellows according to another embodiment of a centering element according to the invention;

FIG. 5 is a sectional view of the pivot-side sealing area of a sealing bellows according to another embodiment of a centering element according to the invention;

FIG. 6 is a sectional view of the pivot-side sealing area of a sealing bellows according to another embodiment of a centering element according to the invention;

FIG. 7 is a sectional view of the pivot-side sealing area of a sealing bellows with a pivot-side guard ring;

FIG. 8 is a sectional view of the pivot-side sealing area of a sealing bellows with a pivot-side guard ring;

FIG. 9 is a sectional view of the pivot-side sealing area of a sealing bellows with a pivot-side guard ring and an additional seal arranged at the guard ring; and

FIG. 10 is a sectional view showing the housing side sealing area of a sealing bellows with seals arranged at the housing surface.

### DESCRIPTION OF THE PREFERRED EMBODIMENTS

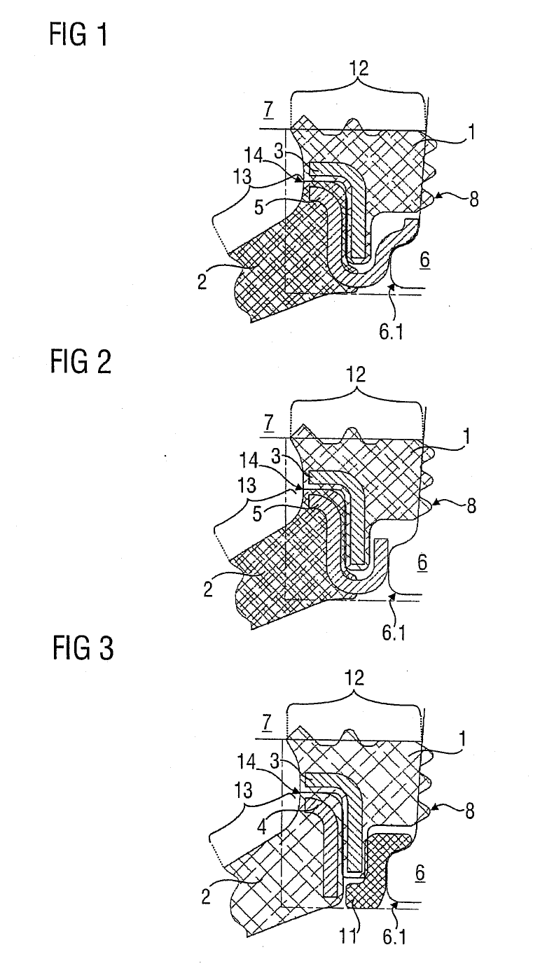

Referring to the drawings in particular, FIG. 1 shows a sectional view of the pivot-like sealing area 12 of a sealing bellows. The sealing bellows is pushed over a pivot 6 (shown only partially) of a ball-and-socket joint. The pivot-side sealing area 12 consists of a sealing rubber 1, which shall possess, for example, the following properties, listed as key words only: Good stretching strain and compression strain, low coefficient of friction against the material of the pivot 3, elasticity down to −20° C., no tendency to fracture down to −40° C., temperature stability possibly up to 120° C. and higher, as well as resistance to oil and grease.

To seal the pivot side, the sealing rubber 1 has three sealing lips 8 in the radial direction of the pivot and two sealing lips in the axial direction of the pivot 6 toward the holder 7 of the lever. The sealing lips 8 are shown in the non-deformed state for simplicity's sake in FIGS. 1 through 9 and they are shown to extend both into the area of the pivot 6 and into the area of the holder 7 of the lever. By screwing the holder 7 of the lever to the pivot 6, the interior space of the ball-and-socket joint is closed in a gap-free manner and tightly.

The sealing rubber 1 is adjoined in the lower left part in FIG. 1 by the jacket rubber 2 of the jacket area 13. The jacket area 13 usually has a bulged cross section in case of a sealing bellows. Only the attachment of the jacket area 13 is shown in FIG. 1 and the bulged shape is therefore not recognizable. The jacket rubber 2 consists of a material different from that of the sealing rubber 1 here. The jacket rubber 2 should possibly have the following properties: weathering resistance and elasticity down to −40° C., temperature stability up to about 100° C., no burning or charring up to about 150° C., and, furthermore, the jacket rubber 2 should be resistant to oil and grease. The sealing rubber 1 and the jacket rubber 2 touch each other at the contact surface 14. Tight closure of the ball-and-socket joint is created at the contact surface 14 either by a pressing pressure and/or by bonding or welding between the sealing rubber 1 and the jacket rubber 2.

A reinforcing element 3, which has an angular cross section, is incorporated in the sealing rubber 1 in the area of the contact surface 14. A combined reinforcing/centering element 5 is correspondingly incorporated in the jacket rubber 2. This combined reinforcing/centering element 5 is surrounded in partial areas by the jacket rubber 2 and other partial areas of the combined reinforcing/centering element 5 extend in the radial and axial directions toward the pivot 6. The combined reinforcing/centering element 5 is seated on a shoulder of the pivot and prevents the jacket area from slipping off in the direction of the pivot shoulder as a result. The combined reinforcing/centering element 5 is used, on the one hand, to center the jacket area 13 in relation to the pivot 6 and to prevent slipping off, and, on the other hand, to create a stable and sealed connection between the materials of the jacket area 13 and the sealing area 12 in the area of the contact surface 14 with the reinforcing element 3 of the sealing rubber 1.

FIG. 2 shows the same sectional view of the pivot-side sealing area 12 from FIG. 1. Unlike in FIG. 1, the combined reinforcing/centering element 5 of the jacket rubber 2 has a different shape in FIG. 2. The combined reinforcing/centering element 5 touches the pivot 3 in the axial direction only, but it does not extend around the shoulder 6.1 ofthe pivot 6. This makes possible the centered positioning and at the same time an axial motion of the jacket rubber 2 along the pivot 6.

FIG. 3 shows another possible embodiment of the pivot-side sealing area 12 of a sealing bellows. During the mounting of a sealing bellows on a ball-and-socket joint, a round centering element 11 with nearly S-shaped cross section is pushed first over the conical pivot 6 until it comes to lie at the shoulder 6.1 of the pivot 6. The jacket rubber 2 of the jacket area 13 is then pushed over the pivot 6 and the centering element 11. The jacket rubber 2 is held by the centering element 11 at a constant distance from the pivot 6 and around same. In the next step, the sealing rubber 1 is pushed over the pivot 6. The sealing rubber 1, which also extends into a gap between the jacket rubber 2 and the centering element 11, is held in a non-positive manner as a result. The centering element 11 acts at the surface of the pivot 6 as a certain sealing protection. However, sealing of the sealing bellows at the pivot 6 is brought about mainly by the three pivot-side sealing lips 8 and the two sealing lips 8 towards the holder 7 of the lever of the sealing rubber 1. At the contact site 14 between the sealing rubber 1 and the jacket rubber 2, the two reinforcing elements 3 and 4 bring about a sealed connection ofthe material. The two reinforcing elements 3 and 4, which are each surrounded by the sealing rubber 1 and the jacket rubber 2, bring about a flat pressing pressure on the rubber material between the reinforcing elements 3 and 4.

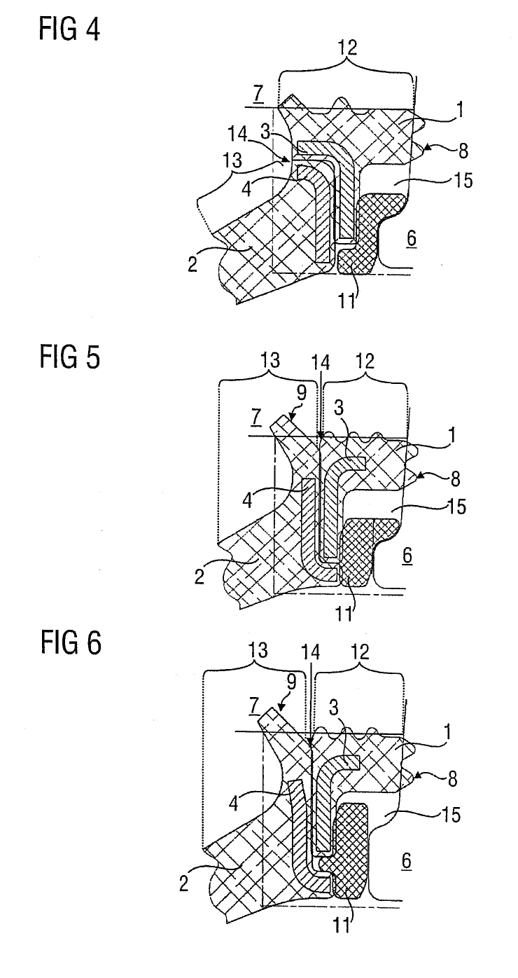

FIG. 4 shows a modified embodiment of the pivot-side sealing area 12 of a sealing bellows, which sealing area is shown in FIG. 3. No rubber material is used in a region at the sealing rubber 1 in the axial direction of the pivot. The number of radially extending sealing lips 8 is reduced as a result to two and a cavity 15 is formed between the sealing rubber 1 and the centering element 11. For example, a grease, which additionally brings about sealing in this area, can be introduced into this cavity 15, which adjoins the pivot 6. As an alternative to this, a lubricating medium, for example, oil, which reduces the friction between the sealing rubber 1 and the pivot 6, may be stored in the cavity 15.

FIG. 5 and FIG. 6 show, respectively, other different embodiments of the pivot-side sealing area 12 with different centering elements 11. Contrary to the variant shown in FIG. 4, the entire contact surface 14 between the sealing rubber 1 and the jacket rubber 2 extends in parallel to the longitudinal axis of the pivot 6. The jacket rubber 2 extends up to the holder 7 of the lever. A sealing lip 9 of the jacket rubber 2 and three sealing lips 8 of the sealing rubber 2 seal the interior space of the ball-and-socket joint at the holder 7 of the lever.

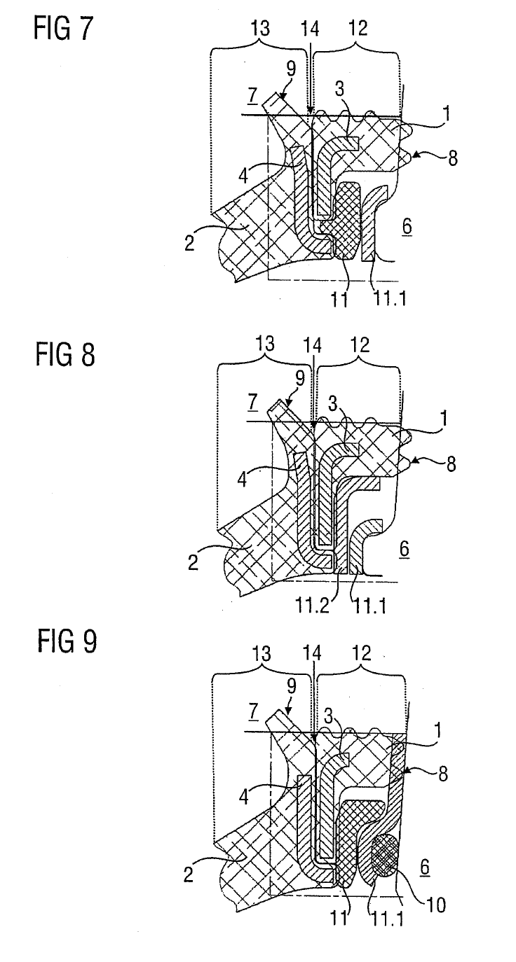

FIG. 7 and FIG. 8 show, respectively, other different embodiments of the pivot-side sealing area 12. A guard ring 11.1 is arranged at the shoulder 6.1 of the pivot 6 in both figures. This guard ring 11.1, which extends both in the axial direction and in the radial direction between the pivot 6 and the centering element 11, reduces the abrasion and thus the wear in the area of the centering element 11. A sealing bellows whose pivot-side sealing area 12 is of such a design has a longer service life as a result.

According to FIG. 8, the centering element 11 is designed as a bellows-side centering ring 11.2, which represents the counter-running surface for the guard ring 11.1. A defined and corrosion-protected guiding of these components, which are rotatably movable in relation to one another, is achieved here. Low-friction relative rotation of the bellows-side centering ring 11.2 in relation to the guard ring 11.1 can be achieved by means of a suitable combination of materials, for example, steel on steel.

FIG. 9 shows another design of the guard ring 11.1 in the pivot-side sealing area 12. Compared to the guard ring 11.1 according to FIGS. 7 and 8, this guard ring 11.1 extends over a greater partial area of the conically extending pivot 6 and has a bulge in the lower part. A second rubber ring 10 can be pressed into this bulge on the guard ring 11.1. The second sealing rubber 10 additionally acts as a redundant seal to the sealing lips 8 and 9 ofthe sealing rubber 1 and of the jacket rubber 2 at the pivot 6.

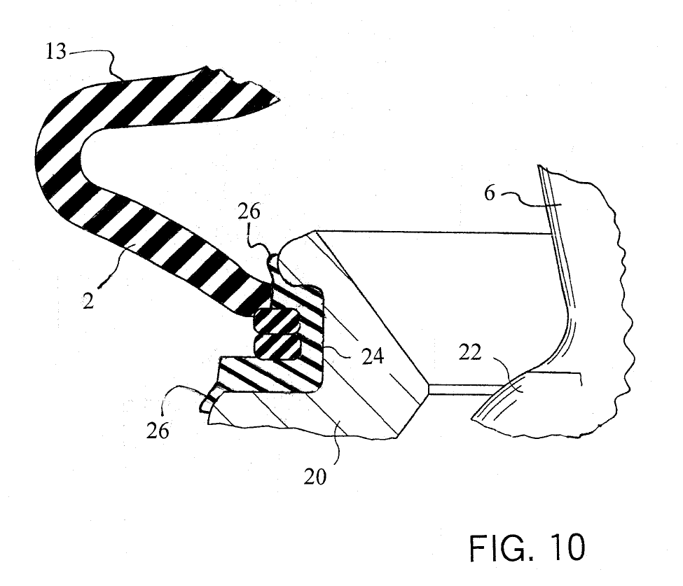

FIG. 10 shows the sealing bellows with the jacket rubber 2 of any of the embodiments of FIGS. 1-9. The a pivot 6 is shown originating from the ball 22 and with a housing 20 accommodating the ball 22. The sealing bellows extends from a connection at the pivot 6 as shown in any of the embodiments of FIGS. 1-9 to the ball housing 20. FIG. 10 shows the sealing bellows having the jacket area 13 and a housing-side sealing area 24. The sealing bellows at the housing-side sealing area 24 consists of a material that differs from the material used for said jacket area 13 of said sealing bellows. The housing-side sealing area 24 has one or more sealing lips 26 of sealing rubber of the housing-side sealing area 24.

It is obvious that the above-mentioned features of the present invention can be used not only in the particular combination indicated but in other combinations or alone as well, without going beyond the scope of the present invention. While specific embodiments of the invention have been shown and described in detail to illustrate the application of the principles of the invention, it will be understood that the invention may be embodied otherwise without departing from such principles.

1. A sealing bellows of a ball-and-socket joint, with a ball, a pivot originating from the ball and with a housing accommodating the ball, the sealing bellows extending between said pivot and the ball housing and the sealing bellows comprising:
a pivot-side sealing area;
a jacket area; and
a housing-side sealing area, said jacket area consisting of an elastomeric material, said pivot-side sealing area of the sealing bellows consisting of a material that differs from the material used for said jacket area of said sealing bellows.

2. A sealing bellows in accordance with claim 1, wherein the material used for said pivot-side sealing area is an elastomer.

3. A sealing bellows in accordance with claim 1, wherein both said pivot-side sealing area and the housing-side sealing area consist of an elastomeric material different from the material of said jacket area.

4. A sealing bellows in accordance with claim 1, wherein said sealing area or both said sealing area and another sealing area, has/have a non-positive and/or positive-locking connection or connection in substance with said jacket area.

5. A sealing bellows in accordance with claim 1, wherein said jacket area has at least one reinforcing element, which is preferably arranged close to the at least one said sealing area.

6. A sealing bellows in accordance with claim 1, wherein said sealing area has at least one reinforcing element, which is preferably arranged close to said jacket area.

7. A sealing bellows in accordance with claim 1, further comprising a reinforcement element provided in at least one of said jacket area and said sealing area wherein said reinforcing element consists of plastic and/or metal.

8. A sealing bellows in accordance with claim 7, wherein said reinforcing element is arranged rotationally symmetrically in relation to said pivot.

9. A sealing bellows in accordance with claim 1, wherein said jacket area and/or said sealing area have at least one sealing lip, which makes possible the sealing of the interior space of the ball-and-socket joint at said pivot or at the housing.

10. A sealing bellows in accordance with claim 1, wherein an additional sealing element is provided at least at one said sealing area.

11. A sealing bellows in accordance with claim 1, wherein at least one centering element is provided at least between said pivot and said pivot-side sealing area and/or between the housing and the housing-side sealing area.

12. A sealing bellows in accordance with claim 1, wherein said jacket area consists of chloroprene rubber; with a hardness of approx. 50±10 Shore A.

13. A sealing bellows in accordance with claim 1, wherein at least one said sealing area consists of a nitrile rubber, preferably with a hardness of approx. 70±10 Shore A.

14. A sealing bellows of a ball-and-socket joint having a ball pivot and a housing accommodating a ball of the ball point, the sealing bellows extending between said ball point and said housing, the sealing bellows comprising:
a pivot-side sealing area; and
a jacket area, said jacket area being formed of an elastomeric material, said pivot-side sealing area consisting of a material that differs from the material forming said jacket area.

15. A sealing bellows in accordance with claim 14, wherein the material forming said pivot-side sealing area is an elastomer.

16. A sealing bellows in accordance with claim 14, further comprising another sealing area adjacent to said pivot sealing area at least one of said pivot sealing area and said another sealing area being one of non-positively connected to said jacket area, positive-lockingly connected to said jacket area and connected in substance with said jacket area.

17. A sealing bellows in accordance with claim 14, further comprising a reinforcing element within said jacket area, said reinforcing element being arranged close to said pivot sealing area.

18. A sealing bellows in accordance with claim 14 further comprising a reinforcing element within said sealing area, said reinforcing element being arranged close to said jacket area.

19. A sealing bellows in accordance with claim 14, further comprising a reinforcement element provided in at least one of said jacket area and said pivot sealing area wherein said reinforcing element is formed of plastic and/or metal.

20. A sealing bellows in accordance with claim 19, wherein said reinforcing element is arranged rotationally symmetrically in relation to said pivot.
